(19) United States
(12) Patent Application Publication
(10) Pub. No.: US 2025/0071850 A1
(43) Pub. Date: Feb. 27, 2025

(54) METHOD AND APPARATUS OF SUPPORTING MULTICAST AND BROADCAST SERVICES (MBS)

(71) Applicant: Lenovo (Beijing) Limited, Beijing (CN)

(72) Inventors: Mingzeng Dai, Shanghai (CN); Lianhai Wu, Beijing (CN); Congchi Zhang, Shanghai (CN); Jing Han, Beijing (CN)

(73) Assignee: Lenovo (Beijing) Limited, Beijing (CN)

(21) Appl. No.: 18/725,172

(22) PCT Filed: Dec. 31, 2021
(86) PCT No.: PCT/CN2021/143818

§ 371 Date: Jun. 28, 2024

(51) Int. Cl. H04W 76/27; H04L 12/18; H04W 48/20; H04W 76/40

(52) U.S. Cl. CPC H04W 76/27; H04W 48/20; H04W 76/40; H04L 12/189

(57) ABSTRACT

Embodiments of the present application relate to a method and apparatus of supporting multicast and broadcast services (MBS). An exemplary method includes: receiving at least one signaling indicating MRB configuration information for multicast reception in RRC non-connected state, wherein the at least one signaling is at least one of: a RRC dedicated signaling received in a RRC connected state or a RRC dedicated signaling received during a state transition from the RRC connected state to the RRC non-connected state; and in response to the state transition from the RRC connected state to the RRC non-connected state, receive, multicast data of MRB in the RRC non-connected state based on the received MRB configuration information for multicast reception in RRC non-connected state.

### TECHNICAL FIELD

Embodiments of the present application generally relate to wireless communication technology, especially to a method and apparatus of supporting multicast and broadcast services (MBS).

### BACKGROUND

In new radio (NR) release (R) 17, MBS plans to focus on a small area mixed mode multicast (also referred to as Objective A in the TR 23.757). The Objective A is about enabling general MBS services over 5G system (5GS) and the identified use cases that could benefit from this feature. These use cases include but are not limited to: public safety and mission critical, vehicle to everything (V2X) applications, transparent internet protocol version 4 (IPv4)/internet protocol version 6 (IPv6) multicast delivery, internet protocol television (IPTV), software delivery over wireless, group communications and internet of things (IoT) applications.

Meanwhile, the work item on NR support of MBS was also agreed in R17 (e.g., RP-201038), wherein MBS reception in all radio resource control (RRC) states, i.e., RRC_IDLE state, RRC_INACTIVE state and RRC_CONNECTED state should be supported in MBS. However, various issues, e.g., service interruption, data loss, or large delay etc., will happen during the transition between different RRC states. Taking multicast reception as an example, it is only supported in RRC_CONNECTED state in R17. When a user equipment (UE) transits from RRC_CONNECTED state to RRC_INACTIVE state or RRC_IDLE state, it cannot receive multicast, e.g., multicast session(s) or multicast radio bearer(s).

Thus, an improved technical solution for MBS considering RRC state transition, e.g., how to support multicast reception in RRC_INACTIVE state should be seriously considered.

### SUMMARY OF THE DISCLOSURE

One objective of the present application is to provide a method and apparatus of supporting MBS, especially supporting multicast reception in a RRC non-connected state.

Some embodiments of the present application provide an exemplary apparatus, e.g., a UE, which includes: a transceiver; and at least one processor coupled to the transceiver, wherein the at least one processor is configured to: receive, via the transceiver, at least one signaling indicating MRB configuration information for multicast reception in RRC non-connected state, wherein the at least one signaling is at least one of: a RRC dedicated signaling received in a RRC connected state or a RRC dedicated signaling received during a state transition from the RRC connected state to the RRC non-connected state; and in response to the UE transiting from the RRC connected state to the RRC non-connected state, receive, via the transceiver, multicast data of the MRB in the RRC non-connected state based on the received MRB configuration information for multicast reception in RRC non-connected state.

In some embodiments of the present application, the MRB configuration information for multicast reception in RRC non-connected state is indicated by: the RRC dedicated signaling received in the RRC connected state indicating the MRB configuration information of the UE for multicast reception; and the RRC dedicated signaling received during the state transition, indicating multicast reception in the RRC non-connected state with continuing using the MRB configuration information of the UE for multicast reception. The MRB configuration information of the UE for multicast reception includes: common MRB configuration information for multicast reception in RRC connected state and RRC non-connected state; and dedicated MRB configuration information for multicast reception in RRC connected state. Accordingly, receiving the multicast data of MRB in the RRC non-connected state may include: receiving the multicast data of MRB in the RRC non-connected state by using the common MRB configuration information for multicast reception in RRC connected state and RRC non-connected state.

In some embodiments of the present application, the at least one signaling is the RRC dedicated signaling received in the RRC connected state, indicating MRB configuration information of the UE for multicast reception. The MRB configuration information of the UE for multicast reception includes: dedicated MRB configuration information for multicast reception in RRC connected state; and dedicated MRB configuration information for multicast reception in RRC non-connected state. Accordingly, receiving the multicast data of MRB in the RRC non-connected state may include: receiving the multicast data of MRB in the RRC non-connected state by using the dedicated MRB configuration information for multicast reception in RRC non-connected state. According to some embodiments of the present application, the MRB configuration information of the UE for multicast reception further includes: common MRB configuration information for multicast reception in RRC connected state and RRC non-connected state. Then, receiving the multicast data of MRB in the RRC non-connected state may include: receiving the multicast data of MRB in the RRC non-connected state by using the dedicated MRB configuration information for multicast reception in RRC non-connected state and the common MRB configuration information for multicast reception in RRC connected state and RRC non-connected state. In addition, the at least one processor may be configured to: receive the RRC dedicated signaling during the state transition, indicating multicast reception in RRC non-connected state.

In some embodiments of the present application, the MRB configuration information for multicast reception in RRC non-connected state includes a set of MRB configurations associated with a set of cells. During the state transition from the RRC connected state to the RRC non-connected state, the at least one processor is configured to: in response to that multicast reception is to be continued or multicast is to be received in the RRC non-connected state, select a cell which provides multicast service or prioritize selecting a cell that is provided an MRB configuration for multicast reception in the RRC non-connected state. According to some embodiments of the present application, the at least one processor is configured to: in response to multicast reception in the RRC non-connected state, prioritize reselecting a cell that is provided an MRB configuration for multicast reception in the RRC non-connected state during a cell reselection procedure. The at least one processor is configured to: for each of the set of cells, receive an offset value of cell to be used during the cell reselection procedure. According to some other embodiments of the present application, the at least one processor is configured to: in response to multicast reception in the RRC non-connected state, prioritize reselecting a frequency to which a cell that is provided an MRB configuration for multicast reception in the RRC non-connected state belongs during the cell reselection procedure. The at least one processor is configured to: for each frequency to which at least one of the set of cells belongs, receive an offset value of frequency to be used during the cell reselection procedure.

In some embodiments of the present application, receiving the multicast in the RRC non-connected state includes at least one of the following: suspend or release a point to point (PTP) leg if any; disable or suspend dedicated MRB configuration(s) for the RRC connected state; continuing receiving multicast of a point to multipoint (PTM) leg or to receive of multicast of a PTM leg of corresponding MRB(s) in the RRC non-connected state; suspend protocol data convergence protocol (PDCP) entities of all data radio bearers (DRB) s except the corresponding MRB(s); perform partial MAC reset; or in response to that multicast is to be continued receiving or is to be received in the RRC non-connected state, select a cell which provides the multicast during the state transition. Suspending the PDCP entities of all DRBs except the corresponding MRB(s) includes at least one of the following: remaining a reordering timer in the case of the reordering timer running; or continuing using an existing value of a state variable indicating a count value of a next PDCP service data unit (SDU) expected to be received and an existing value of a state variable indicating a count value of a first PDCP SDU being not delivered to upper layers but still waited for. Performing partial MAC reset includes: flushing soft buffers for downlink hybrid automatic repeat request (HARQ) process related to unicast service radio bearers (SRB) s and DRBs except the corresponding MRB(s).

In some embodiments of the present application, the at least one processor is configured to: receive a timer for indicating valid time of the MRB configuration information for multicast reception in RRC non-connected state; and enter the RRC connected state to update the MRB configuration information for multicast reception in RRC non-connected state in response to the timer expiring in the RRC non-connected state.

According to some embodiments of the present application, an exemplary apparatus is a network apparatus, which includes: a transceiver; and at least one processor coupled to the transceiver, wherein the at least one processor is configured to: transmit, via the transceiver, at least one signaling indicating MRB configuration information for multicast reception in RRC non-connected state, wherein the at least one signaling is at least one of: a RRC dedicated signaling to be received by a UE in a RRC connected state or a RRC dedicated signaling to be received by the UE during a state transition from the RRC connected state to the RRC non-connected state; and transmit, via the transceiver, multicast data of MRB in the RRC non-connected state based on the MRB configuration information for multicast reception in RRC non-connected state.

Some embodiments of the present application also provide an exemplary method, which includes: receiving at least one signaling indicating MRB configuration information for multicast reception in RRC non-connected state, wherein the at least one signaling is at least one of: a RRC dedicated signaling received in a RRC connected state or a RRC dedicated signaling received during a state transition from the RRC connected state to the RRC non-connected state; and in response to the state transition from the RRC connected state to the RRC non-connected state, receiving multicast in the RRC non-connected state based on the MRB configuration information for multicast reception in RRC non-connected state.

Some embodiments of the present application provide another exemplary apparatus, e.g., a UE, which includes: a transceiver; and at least one processor coupled to the transceiver, wherein the at least one processor is configured to: receive, via the transceiver, an indication indicating that MRB configuration information for multicast reception is to be indicated only in RRC dedicated signaling, or only in multicast control channel (MCCH), or in both of RRC dedicated signaling and MCCH; and receive, via the transceiver, the MRB configuration information for multicast reception based on the indication.

In some embodiments of the present application, in the case that the indication indicates that the MRB configuration information for multicast reception is to be indicated only in MCCH, the at least one processor is configured to: receive the MRB configuration information for multicast reception in a MCCH, and the MRB configuration information for multicast reception is used for multicast reception in a RRC connected state and a RRC non-connected state.

In some embodiments of the present application, in the case that the indication indicates that the MRB configuration information for multicast reception is to be indicated in both RRC dedicated signaling and MCCH, the at least one processor is configured to: receive the MRB configuration information for multicast reception in a RRC dedicated signaling in a RRC connected state and an MCCH, wherein, the MRB configuration information for multicast reception received in the RRC dedicated signaling is dedicated MRB configuration information for multicast reception in RRC connected state, and the MRB configuration information for multicast reception received in the MCCH is common MRB configuration information for multicast reception in RRC connected state and RRC non-connected state. According to some embodiments of the present application, the at least one processor is configured to: receive the multicast data of MRB in the RRC connected state by using the dedicated MRB configuration information for multicast reception in RRC connected state; and receive the multicast data of MRB in the RRC non-connected state by using the dedicated MRB configuration information for multicast reception in RRC non-connected state. In the RRC non-connected state, the at least one processor is configured to: monitor the MCCH and MCCH update notification; and suspend or release the dedicated MRB configuration information for multicast reception in RRC connected state. The at least one processor is configured to: in response to initializing a procedure to re-enter the RRC connected state, restore the dedicated MRB configuration information for multicast reception in RRC connected state.

In some embodiments of the present application, in the case that the indication indicates that the MRB configuration information for multicast reception is to be indicated only in RRC dedicated signaling, the at least one processor is configured to: receive the MRB configuration information for multicast reception in a RRC dedicated signaling in a RRC connected state. According to some embodiments of the present application, the MRB configuration information for multicast reception includes: common MRB configuration information for multicast reception in RRC connected state and RRC non-connected state; and dedicated MRB configuration information for multicast reception in RRC connected state; wherein, the at least one processor is configured to: receive a RRC dedicated signaling during a state transition from the RRC connected state to the RRC non-connected state, indicating multicast reception in the RRC non-connected state by using the common MRB configuration information for multicast reception. According to some other embodiments of the present application, the MRB configuration information for multicast reception includes: dedicated MRB configuration information for multicast reception in RRC connected state; and dedicated MRB configuration information for multicast reception in RRC non-connected state. Receiving the multicast data of MRB in the RRC non-connected state may include: receiving the multicast data of MRB in the RRC non-connected state by using the dedicated MRB configuration information for multicast reception in RRC non-connected state.

According to some embodiments of the present application, another exemplary apparatus is a network apparatus, which includes: a transceiver; and at least one processor coupled to the transceiver, wherein the at least one processor is configured to: transmit, via the transceiver, an indication indicating that MRB configuration information for multicast reception is to be indicated only in RRC dedicated signaling, or only in MCCH, or in both of RRC dedicated signaling and MCCH; and transmit, via the transceiver, the MRB configuration information for multicast reception based on the indication.

Some other embodiments of the present application also provide another exemplary method, which includes: receiving an indication indicating that MRB configuration information for multicast reception is to be indicated only in RRC signaling, or only in MCCH, or in both of RRC dedicated signaling and MCCH; and receiving the MRB configuration information for multicast reception based on the indication.

Embodiments of the present application can solve the technical problems occurring during RRC state transition in MBS, supporting multicast reception in a RRC non-connected state, e.g., RRC_INACTIVE state, and thus will facilitate the deployment and implementation of the NR.

### BRIEF DESCRIPTION OF THE DRAWINGS

In order to describe the manner in which the advantages and features of the disclosure can be obtained, a description of the disclosure is rendered by reference to specific embodiments thereof, which are illustrated in the appended drawings. These drawings depict only exemplary embodiments of the disclosure and are not therefore to be considered limiting of its scope.

FIG. 1 is a schematic diagram illustrating an exemplary wireless communication system according to some embodiments of the present application.

FIG. 2 is a schematic diagram illustrating an exemplary scenario of RRC state transition for multicast reception according to some embodiments of the present application.

FIG. 3 is a flow chart illustrating an exemplary method of supporting MBS according to some embodiments of the present application.

FIG. 4 is a flow chart illustrating an exemplary method of supporting MBS under Scheme 1 according to some embodiments of the present application.

FIG. 5 is a flow chart illustrating an exemplary method of supporting MBS under Scheme 2 according to some embodiments of the present application.

FIG. 6 is a flow chart illustrating an exemplary method of supporting MBS according to some other embodiments of the present application.

FIG. 7 is a flow chart illustrating an exemplary method of supporting MBS according to some other embodiments of the present application.

FIG. 8 illustrates a block diagram of an exemplary apparatus of supporting MBS according to some embodiments of the present application.

FIG. 9 illustrates a block diagram of an exemplary apparatus of supporting MBS according to some other embodiments of the present application.

### DETAILED DESCRIPTION

The detailed description of the appended drawings is intended as a description of the preferred embodiments of the present application and is not intended to represent the only form in which the present application may be practiced. It should be understood that the same or equivalent functions may be accomplished by different embodiments that are intended to be encompassed within the spirit and scope of the present application.

Reference will now be made in detail to some embodiments of the present application, examples of which are illustrated in the accompanying drawings. To facilitate understanding, embodiments are provided under specific network architecture and new service scenarios, such as 3rd generation partnership project (3GPP) 5G, 3GPP long term evolution (LTE), and so on. It is contemplated that along with the developments of network architectures and new service scenarios, all embodiments in the present application are also applicable to similar technical problems; and moreover, the terminologies recited in the present application may change, which should not affect the principle of the present application.

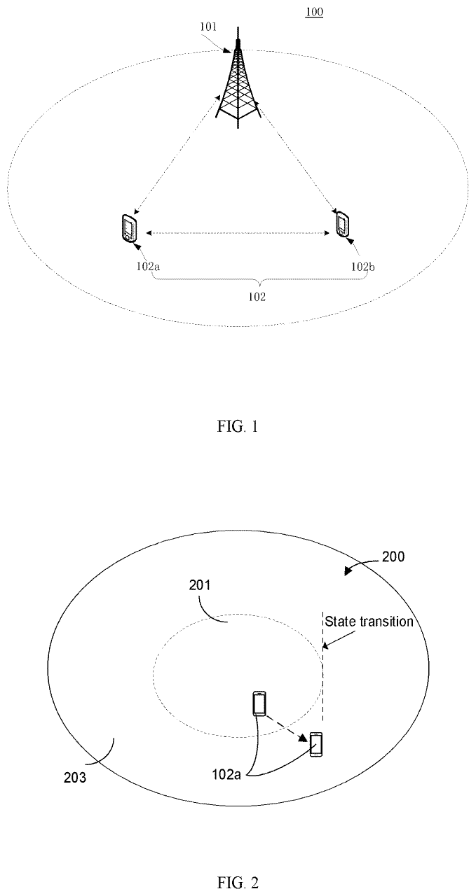

FIG. 1 illustrates a schematic diagram of an exemplary wireless communication system 100 according to some embodiments of the present application.

As shown in FIG. 1, the wireless communication system 100 includes at least one base station (BS) 101 and at least one UE 102. In particular, the wireless communication system 100 includes one BS 101 and two UE 102 (e.g., a first UE 102a and a second UE 102b) for illustrative purpose. Although a specific number of BSs and UEs are illustrated in FIG. 1 for simplicity, it is contemplated that the wireless communication system 100 may include more or less BSs and UEs in some other embodiments of the present application.

The wireless communication system 100 is compatible with any type of network that is capable of sending and receiving wireless communication signals. For example, the wireless communication system 100 is compatible with a wireless communication network, a cellular telephone network, a time division multiple access (TDMA)-based network, a code division multiple access (CDMA)-based network, an orthogonal frequency division multiple access (OFDMA)-based network, an LTE network, a 3GPP-based network, a 3GPP 5G network, a satellite communications network, a high altitude platform network, and/or other communications networks.

The BS 101 may communicate with a CN node (not shown), e.g., a mobility management entity (MME) or a serving gateway (S-GW), a mobility management function (AMF) or a user plane function (UPF) etc. via an interface. A BS also be referred to as an access point, an access terminal, a base, a macro cell, a node-B, an enhanced node B (eNB), a gNB, a home node-B, a relay node, or a device, or described using other terminology used in the art. In 5G NR, a BS may also refer to as a RAN node or network apparatus. Each BS may serve a number of UE(s) within a serving area, for example, a cell or a cell sector via a wireless communication link. Neighbor BSs may communicate with each other as necessary, e.g., during a handover procedure for a UE.

The UE 102, e.g., the first UE 102a and second UE 102b should be understood as any type terminal device, which may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. According to an embodiment of the present application, the UE may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments, the UE may include wearable devices, such as smart watches, fitness bands, optical head-mounted displays, or the like. Moreover, the UE may be referred to as a subscriber unit, a mobile, a mobile station, a user, a terminal, a mobile terminal, a wireless terminal, a fixed terminal, a subscriber station, a user terminal, or a device, or described using other terminology used in the art.

MBS was introduced to focus on a small area mixed mode multicast in NR R17, wherein multicast is only supported in RRC_CONNECTED state. Since HARQ and PTM/PTP dynamic switch are supported for high reliability, multicast reception in RRC_CONNECTED state can provide high quality of service (QOS) experience. That means, when UE being receiving multicast enters a non-connected state, e.g., RRC_INACTIVE state from RRC_CONNECTED state, it cannot continue receiving the multicast. The multicast reception in the UE will be interrupted. Thus, one potential objective of MBS in R18 is to support multicast reception in a non-connected state, e.g., in RRC_INACTIVE state, so that some UEs in RRC_CONNECTED state that are receiving multicast or are configured to receive multicast can be released (or sent) to a non-connected state, e.g., RRC_INACTIVE state to at least relieve network congestion.

FIG. 2 is a schematic diagram illustrating an exemplary scenario of RRC state transition for multicast reception according to some embodiments of the present application.

As shown in FIG. 2, for a coverage 200 provided by a BS, e.g., the BS 101 shown in FIG. 1, it generally includes a good coverage area 201, e.g., the center area of the coverage 200; and a bad coverage area 203, e.g., the edge area of the coverage 200. Taking a UE, e.g., the first UE 102a shown in FIG. 1 as an example, it is supposed that the first UE 102a can receive multicast in both RRC_CONNECTED state and RRC_INACTIVE state. When the first UE 102a is located in the good coverage area 201 and is receiving multicast or is configured to receive multicast, the first UE 102a may be released to RRC_INACTIVE state by the BS to relieve congestion in the coverage 200. That is, the first UE 102a is transited (or switched) from RRC_CONNECTED state to RRC_INACTIVE state. The first UE 102a can continue receiving the multicast in RRC_INACTIVE state. If the first UE 102a is still in the good coverage area 201 and has low mobility, the QoS experienced by the first UE 102a is likely to be similar to that in RRC_CONNECTED state.

However, to support multicast reception by UEs in a RRC non-connected state, e.g., RRC_INACTIVE state, PTM configuration for multicast reception in RRC_INACTIVE state shall be solved. Currently, there is only PTM configuration for multicast reception in RRC_CONNECTED state.

At least for solving the above technical problem, embodiments of the present application propose an improved technical solution for MBS, e.g., a method and apparatus of supporting MBS, where MRB configuration information for multicast reception (or, PTM configuration of an MRB, or multicast MRB configuration) in RRC non-connected state is provided for UE to receive multicast (or multicast data of MRB) in the RRC non-connected state. According to some embodiments of the present application, receiving the multicast in the RRC non-connected state by the UE includes at least one of the following:
a) suspend or release a PTP leg if any;
b) disable or suspend the dedicated MRB configuration(s) for the RRC connected state;
c) continuing receiving multicast of a PTM leg or to receive of multicast of a PTM leg of the corresponding MRB(s) in the RRC non-connected state;
d) suspend PDCP entities of all data radio bearers (DRB) s except the corresponding MRB(s);
e) perform partial MAC reset; and
f) in response to that multicast reception is to be continued or multicast is to be received in the RRC non-connected state, select a cell which provides multicast service or prioritize selecting a cell that is provided an MRB configuration for multicast reception in the RRC non-connected state.
   Wherein, suspending the PDCP entities of all DRBs except the corresponding MRB(s) may include remaining (e.g., not stopping or resetting) a reordering timer of the corresponding MRB in the case of the reordering timer being running in some embodiments of the present application. In some other embodiments of the present application, suspending the PDCP entities of all DRBs except the corresponding MRB(s) may include continuing using an existing value of a state variable indicating a count value of a next PDCP SDU expected to be received (e.g., RX_NEXT) and an existing value of a state variable indicating a count value of a first PDCP SDU being not delivered to upper layers but still waited for (e.g., RX_DELIV), that is, the UE does not set RX_NEXT and RX_DELIV to the initial value of the corresponding MRB. In some yet other embodiments of the present application, suspending the PDCP entities of all DRBs except the corresponding MRB(s) may include both of the operations, i.e., remaining the reordering timer and continuing using an existing value of RX_NEXT and RX_DELIV of the corresponding MRB. Regarding performing partial MAC reset, it may include: flushing soft buffers for downlink HARQ process related to unicast SRBs and DRBs except the corresponding MRB(s), that is, the UE only flushes the soft buffers for all downlink HARQ process related to unicast SRBs and DRBs except the corresponding MRB(s).

Currently, in RRC_CONNECTED state, the PTM configuration of an MRB is provided by RRC dedicated signaling, i.e., RRCReconfiguration message. Considering that, according to some embodiments of the present application, the MRB configuration information for multicast reception in RRC non-connected state can also be provided by RRC dedicated signaling (Scheme 1), for example, by the same RRC dedicated signaling for the PTM configuration of an MRB in RRC_CONNECTED state. However, when the UE enters RRC_INACTIVE state, the RRC dedicated configuration for RRC_CONNECTED state will be suspended. Thus, the UE cannot directly use the MRB configuration information for multicast reception indicated in a RRC connected state for multicast reception in a RRC non-connected state, e.g., in RRC_INACTIVE state. How to configure (or provide) the MRB configuration information for multicast reception in RRC non-connected state by RRC dedicated signaling still needs to be studied and solved.

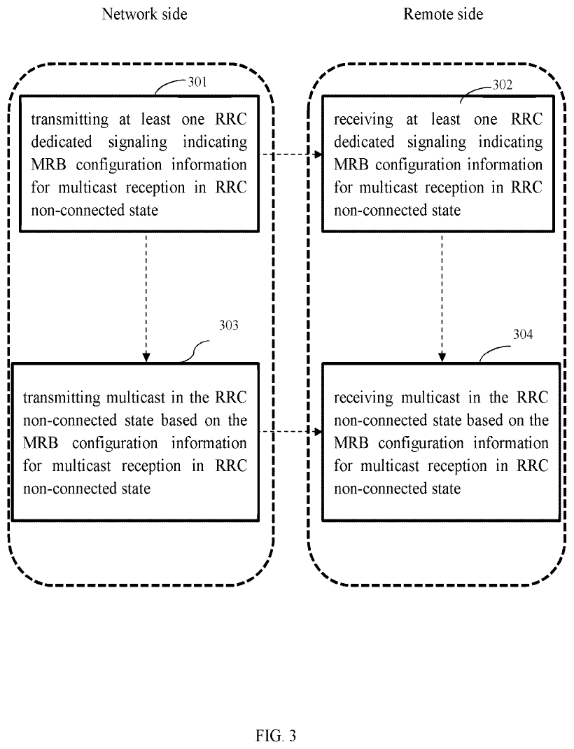

FIG. 3 is a flow chart illustrating an exemplary method of supporting MBS according to some embodiments of the present application. Although the method is illustrated in a system level by a remote apparatus in the remote side (e.g., the UE 102 as illustrated and shown in FIG. 1) and a network apparatus in the network side (e.g., the BS 101 as illustrated and shown in FIG. 1), persons skilled in the art should understand that the method implemented in the remote side and that implemented in the network side can be separately implemented and/or incorporated by other apparatus with the like functions. In addition, it is supposed that the UE supports the multicast reception both in RRC connected state (e.g., RRC_CONNECTED state) and RRC non-connected state (e.g., RRC_INACTIVE state).

Referring to FIG. 3, to enable a UE to continue receiving multicast in a RRC non-connected state or configure a UE to receive multicast in a RRC non-connected state, the network side, e.g., a gNB may transmit at least one signaling indicating MRB configuration information for multicast reception in RRC non-connected state in step 301. The at least one signaling is a RRC dedicated signaling to be received by the UE in the RRC connected state, e.g., RRCReconfiguration message, or a RRC dedicated signaling to be received by the UE during a state transition from the RRC connected state to the RRC non-connected state, e.g., RRCRelease message, or a combination of a RRC dedicated signaling to be received by the UE in the RRC connected state and a RRC dedicated signaling to be received by the UE during a state transition from the RRC connected state to the RRC non-connected state. Then, in step 303, the network side will transmit multicast (or multicast data of MRB) to the UE in the RRC non-connected state based on the MRB configuration information for multicast reception in RRC non-connected state.

Consistently, in the remote side, the UE will receive the at least one signaling indicating the MRB configuration information for multicast reception in RRC non-connected state in step 302. After receiving the at least one signaling and entering the RRC non-connected state, the UE will receive the multicast in the RRC non-connected state in step 304 based on the received MRB configuration information for multicast reception in RRC non-connected state.

In some embodiments of the present application, the network side may also configure a timer to the UE. The timer indicates the valid time of the MRB configuration information for multicast reception in RRC non-connected state. In response to the timer expiring in the RRC non-connected state, the UE will enter the RRC connected state to update the MRB configuration information for multicast reception in RRC non-connected state.

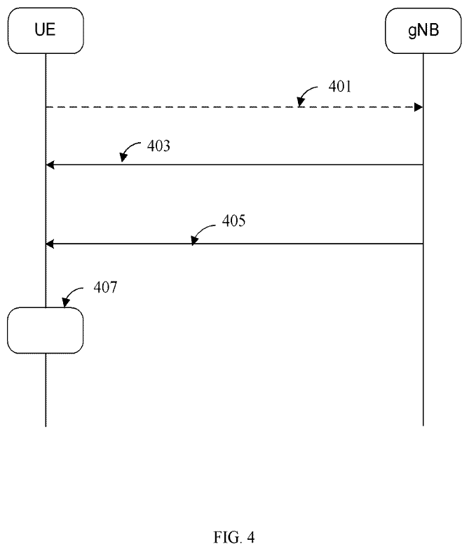

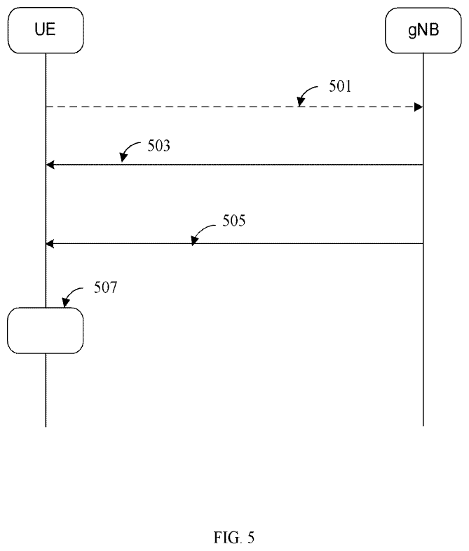

More details on Scheme 1 will be illustrated as follows by referring to FIGS. 4, 5 and 6, where both the MRB configuration information for multicast reception in RRC connected state and the MRB configuration information for multicast reception in RRC non-connected state is indicated by RRC dedicated signaling. Hereafter, for simplification, MRB configuration information for multicast reception in RRC connected state is also referred to “the first MRB configuration information.”

FIG. 4 is a flow chart illustrating an exemplary method of supporting MBS under Scheme 1 according to some embodiments of the present application.

As shown in FIG. 4, optionally, in step 401, a UE may report its capability of supporting multicast reception, e.g., capability of supporting multicast reception in RRC connected state only, or capability of supporting multicast reception in RRC non-connected state, or capability of supporting multicast reception in both RRC connected state and RRC non-connected state. The capability of supporting multicast reception, e.g., capability of supporting multicast reception in RRC non-connected state may be reported per frequency or per carrier or per frequency band.

It is supposed that the UE supports multicast reception in both of the RRC connected state and RRC non-connected state, e.g., the RRC inactive state. For a UE to receive multicast in the RRC connected state, the network side, e.g., a gNB may configure MRB configuration information for multicast reception in RRC connected state and transmit the same to the UE in step 403 via a RRC dedicated signaling, e.g., RRCReconfiguration message. The MRB configuration information for multicast reception in RRC connected state, i.e., the first MRB configuration information includes common MRB configuration information for multicast reception in RRC connected state and RRC non-connected state (e.g., referred to as the common configuration part), and dedicated MRB configuration information for multicast reception in RRC connected state (e.g., referred to as the connection dedicated configuration part). The common configuration part may include the service data adaptation protocol (SDAP) configuration, PDCP configuration and PTM related configuration etc., common multicast MRB configuration. The connection dedicated configuration part can provide UE dedicated configuration for multicast reception in RRC connected state, e.g., related to HARQ feedback and PTP transmission. The common configuration part and the connection dedicated configuration part can be indicated to the UE explicitly or implicitly. For example, the connection dedicated configuration part can be explicitly indicated by indicating (or specifying) that the associated parameter or field is only used for multicast reception in RRC connection state. The remaining parameters or fields associated with multicast reception without explicit specifications implicitly mean that they can be used for multicast reception in both of RRC connected state and RRC non-connected state, i.e., the common configuration part.

In some scenarios, the network side may release the UE from the RRC connected state to the RRC non-connected state in step 405. For example, when network congestion happens, the network side, e.g., a gNB may release (or send) the UE (which is receiving multicast or is to receive multicast) in the RRC connected state to the RRC non-connected state, e.g., to the RRC_INACTIVE state by a RRCRelease message, and configure the UE to continue receiving the multicast in the RRC_INACTIVE state with the MRB configuration information for multicast reception in RRC connected state. That is, the first MRB configuration information will be continuously used in the RRC non-connected state. Considering that the first MRB configuration information is supposed to be used for the multicast reception in RRC connected state, the network side will indicate the UE to continue using the first MRB configuration information in the RRC non-connected state by an indication in a RRC dedicated signaling transmitted during a state transition from the RRC connected state to the RRC non-connected state, e.g., in RRCRelease message.

After receiving the indication, the UE will continue using the first MRB configuration information for multicast reception in the RRC non-connected state in step 407. Since the connection dedicated configuration part is not scalable for UE in a RRC non-connected state, for multicast reception in RRC non-connected state, the UE substantially can only continue using the common configuration part of the first MRB configuration information.

According to some embodiments of the present application, the network side may also configure dedicated MRB configuration information for multicast reception in RRC non-connected state.

FIG. 5 is a flow chart illustrating an exemplary method of supporting MBS under Scheme 1 according to some other embodiments of the present application.

As shown in FIG. 5, optionally, in step 501, a UE may report its capability of supporting multicast reception, e.g., capability of supporting multicast reception in RRC connected state only, or capability of supporting multicast reception in RRC non-connected state, or capability of supporting multicast reception in RRC connected state and RRC non-connected state. The capability of supporting multicast reception, e.g., capability of supporting multicast reception in RRC non-connected state may be reported per frequency or per carrier or per frequency band.

Similarly, it is supposed that the UE supports multicast reception in both of the RRC connected state and RRC non-connected state, e.g., the RRC inactive state. For a UE to receive multicast, the network side, e.g., a gNB may configure MRB configuration information for multicast reception and transmit it to the UE in step 503 via a RRC dedicated signaling, e.g., RRCReconfiguration message. The MRB configuration information for multicast reception includes dedicated MRB configuration information for multicast reception in RRC connected state (e.g., referred to as the connection dedicated configuration part), and dedicated MRB configuration information for multicast reception in RRC non-connected state (e.g., referred to as the non-connection dedicated configuration part). The connection dedicated configuration part can provide UE dedicated configuration for multicast reception in RRC connected state, e.g., related to HARQ feedback and PTP transmission.

In some other embodiments of the present application, the MRB configuration information for multicast reception may also include common MRB configuration information for multicast reception in RRC connected state and RRC non-connected state (e.g., referred to as the common configuration part).

In some scenarios, e.g., to relieve network congestion, the network side, e.g., a gNB may release (or send) the UE (which is receiving multicast or is to receive multicast) in the RRC connected state to the RRC non-connected state, e.g., to the RRC_INACTIVE state in step 505. Since the MRB configuration information for multicast reception includes the non-connection dedicated configuration part, the UE will continue receiving the multicast or is to receive the multicast in the RRC non-connected state even without an additional indication as recited in FIG. 4. That is, such an indication is optional when the MRB configuration information for multicast reception includes the non-connection dedicated configuration part.

In the case that the MRB configuration information for multicast reception only include the connection dedicated configuration part and the non-connection dedicated configuration part, the UE in the RRC non-connected state will use the non-connection dedicated configuration part for the multicast reception in RRC non-connected state in step 507. In the case that the MRB configuration information for multicast reception include the connection dedicated configuration part, the non-connection dedicated configuration part, and the common configuration part, the UE in the RRC non-connected state will use the non-connection dedicated configuration part and the common configuration part for the multicast reception in RRC non-connected state in step 507.

According to some embodiments of the present application, multicast MRB configuration, i.e., MRB configuration information for multicast reception is provided by MCCH (Scheme 2), which was introduced for broadcast MRB only in R17. Similar to broadcast MRB, MCCH can also carry information on the configuration of broadcast MRB, e.g., in MRB Configuration message which indicates the scheduling information for each session (or bearer), e.g., scheduling period, scheduling window and start offset. MCCH information is transmitted periodically using a configurable repetition period. UEs either in the RRC connected state or in the RRC non-connected state can monitor and read MCCH to get the configuration of the multicast MRB, and use the configuration of the multicast MRB for multicast reception either in the RRC connected state or in the RRC non-connected state. However, the MRB configuration information for multicast reception provided in MCCH is only the common part of MRB configuration information for multicast reception in RRC connected state and RRC non-connected state, e.g., the SDAP configuration, PDCP configuration and other common configuration information related to multicast MRB. Thus, in Scheme 2, no UE dedicated MRB configuration information for multicast reception will be provided for the multicast reception in the RRC connection state.

Change of MCCH information only occurs at specific radio frames, i.e., a modification period. Within a modification period, the same MCCH information may be transmitted a number of times, as defined by its scheduling information which is based on a repetition period. When the network changes a part of or all of the MCCH information, it first notifies UEs about the change during a first modification period. Then, in the next modification period, the network will transmit the updated MCCH information to the UEs.

As stated above, both Scheme 1 and Scheme 2 have their respective advantages and disadvantages. For example, RRC dedicated signaling can provide UEs dedicated configuration, but it is not scalable for UEs in RRC non-connected state. On the other hand, although MCCH can be used for multicast reception both in the RRC connected state and RRC non-connected state, it cannot provide UEs dedicated configuration. When there are a small number of UEs, using MCCH will waste radio resource and cause more UE power consumption. Thus, it would be better to allow the network to have the flexibility to configure multicast MRB with different schemes.

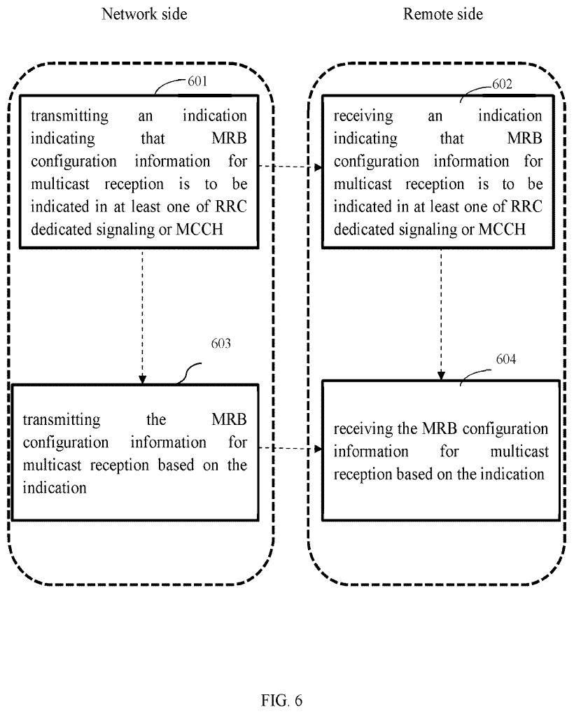

FIG. 6 is a flow chart illustrating an exemplary method of supporting MBS according to some other embodiments of the present application. Although the method is illustrated in a system level by a remote apparatus in the remote side (e.g., the UE 102 as illustrated and shown in FIG. 1) and a network apparatus in the network side (e.g., the BS 101 as illustrated and shown in FIG. 1), persons skilled in the art should understand that the method implemented in the remote side and that implemented in the network side can be separately implemented and/or incorporated by other apparatus with the like functions. In addition, it is supposed that the UE supports the multicast reception both in RRC connected state and RRC non-connected state (e.g., RRC inactive state), and more than one scheme for multicast MRB configuration, e.g., Scheme 1 and Scheme 2 is supported in the UE.

Referring to FIG. 6, the network can flexibly configure multicast MRB, e.g., by Scheme 1 or Scheme 2 or a combination of Scheme 1 and Scheme 2. To ensure the UE can obtain the MRB configuration information for multicast reception correctly, the network side, e.g., a gNB will first transmit an indication in step 601, indicating that the MRB configuration information for multicast reception is to be indicated only in RRC dedicated signaling (Scheme 1), or only in MCCH (Scheme 2), or in both of RRC dedicated signaling and MCCH (a combination of Scheme 1 and Scheme 2). The indication can be transmitted in system information, e.g., system information block (SIB) or RRC signaling. The network side will transmit the MRB configuration information for multicast reception based on the indication in step 603.

Consistently, in the remote side, the UE will receive the indication which indicates by which scheme the multicast MRB will be configured in step 602. After receiving the indication, the UE will receive the MRB configuration information for multicast reception based on the indication in step 604. For example, if the indication indicates that the MRB configuration information for multicast reception is to be indicated only in RRC dedicated signaling, the UE will receive the MRB configuration information for multicast reception by monitoring and reading the RRC dedicated signaling as illustrated in Scheme 1. If the indication indicates that the MRB configuration information for multicast reception is to be indicated only in MCCH, the UE will receive the MRB configuration information for multicast reception by monitoring and reading the MCCH as illustrated in Scheme 2. If the indication indicates that the MRB configuration information for multicast reception is to be indicated in both RRC dedicated signaling and MCCH, the UE will receive the MRB configuration information for multicast reception by the RRC dedicated signaling and monitoring and reading MCCH.

Scheme 1 and Scheme 2 can be combined in various manners. For example, in the case that the indication indicates that the MRB configuration information for multicast reception is to be indicated in both RRC dedicated signaling and MCCH, the MRB configuration information for multicast reception is transmitted and received in a RRC dedicated signaling in the RRC connected state and an MCCH. The MRB configuration information for multicast reception received in the RRC dedicated signaling is dedicated MRB configuration information for multicast reception in RRC connected state, and the MRB configuration information for multicast reception received in the MCCH is common MRB configuration information for multicast reception in RRC connected state and RRC non-connected state. The network side, e.g., a gNB will use the dedicated MRB configuration information for multicast reception in RRC connected state and the common MRB configuration information for multicast reception in RRC connected state and RRC non-connected state to transmit multicast in RRC connected state, and will use the common MRB configuration information for multicast reception in RRC connected state and RRC non-connected state to transmit multicast in RRC non-connected state. Consistently, the UE will use the dedicated MRB configuration information for multicast reception in RRC connected state and the common MRB configuration information for multicast reception in RRC connected state and RRC non-connected state to receive multicast in RRC connected state, and will use the common MRB configuration information for multicast reception in RRC connected state and RRC non-connected state to receive multicast in the RRC non-connected state.

In the RRC non-connected state, the UE will monitor the MCCH and MCCH update notification, and suspend (or release) the dedicated MRB configuration information for multicast reception in RRC connected state. In response to initializing a procedure to re-enter the RRC connected state, the UE will restore the dedicated MRB configuration information for multicast reception in RRC connected state.

In some embodiments of the present application, the MRB configuration information for multicast reception in RRC non-connected state may include a set of MRB configurations associated with a set of cells, which is adaptive to any scheme as stated above. Accordingly, when the UE moves among the set of cells, the UE does not need to enter RRC connected state and can use the MRB configuration information of the corresponding cell for multicast reception in RRC non-connected state.

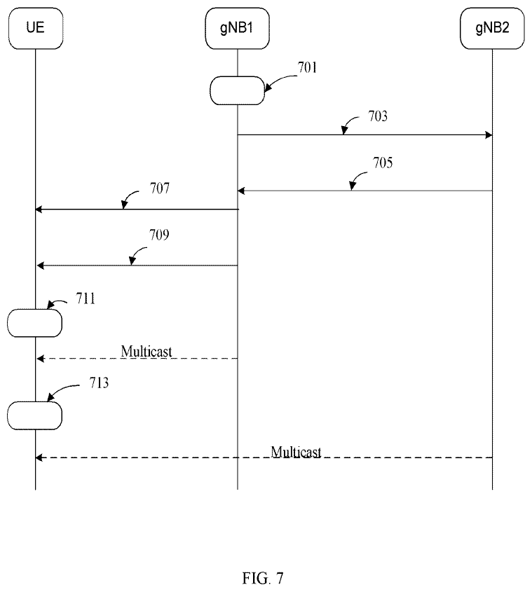

FIG. 7 is a flow chart illustrating an exemplary method of supporting MBS according to some other embodiments of the present application. Although only two BSs, e.g., gNB1 and gNB2 are shown in FIG. 7, persons skilled in the art should well know that there will be more than two BSs or the like and similar operations will be applied.

Referring to FIG. 7, before sending the UE to a RRC non-connected state, in step 701, gNB1, e.g., the serving gNB of the UE may decide a list of cells, where the UE may receive multicast in the RRC non-connected state. The cells on the list may belong to gNB and neighbor BS(s), e.g., gNB(s). The neighbor BS(s) may be the same neighbor BS or different neighbor BSs.

In step 703, gNB1 may request MRB configuration information for multicast reception in RRC non-connected state in each corresponding cell from the associated neighbor gNB, e.g., gNB2 to which the corresponding cell belongs. gNB1 may also provide a list of cell IDs to gNB2. gNB2 will provide the MRB configuration information for multicast reception in RRC non-connected state in the required cell(s) to gNB1 in step 705. The exchange between gNB1 and gNB2 may be carried by Xn-access protocol (AP) signaling.

In step 707, gNB1 will transmit the MRB configuration information for multicast reception in RRC non-connected state of a set of cells to the UE before releasing it to a RRC non-connected state, e.g., by a RRC dedicated signaling in RRC connected state, or by MCCH, or by a combination of RRC dedicated signaling and MCCH. For example, it is supposed that the MRB configuration information for multicast reception in RRC non-connected state of all the cells in the list are obtained by gNB1, and gNB1 will transmit the MRB configuration information for multicast reception in RRC non-connected state of all the cells in the list to the UE.

In step 709, gNB1 will release the UE to the RRC non-connected state, e.g., by RRCRelease message. In the case that an indication is needed, e.g., as in Scheme 1, gNB1 will also include the indication in RRCRelease message.

For the UE, if multicast reception is to be continued receiving or multicast is to be received in the RRC non-connected state, then during the state transition from RRC connected state to RRC non-connected state, the UE will select a cell which provides multicast service or prioritize selecting a cell that is provided an MRB configuration for multicast reception in the RRC non-connected state in step 711. For example, the UE may select a cell belonging to gNB1 and providing multicast service, or the UE will prioritize selecting a cell whose MRB configuration for multicast reception in RRC non-connected state has been provided. Then after entering the RRC non-connected state, the UE will receive multicast in the selected cell.

Due to the mobility of the UE, the UE may move out the coverage of gNB1 and move into the coverage of another BS, e.g., gNB2. If the UE is to continue receiving multicast in the RRC non-connected state, it will prioritize reselecting a cell that is provided an MRB configuration for multicast reception in the RRC non-connected state during a cell reselection procedure in step 713. For each of the set of cells, an offset value of cell configured by the network side will be used by the UE during the cell reselection procedure. In some other embodiments of the present application, the UE will prioritize reselecting a frequency to which a cell that is provided an MRB configuration for multicast reception in the RRC non-connected state belongs during the cell reselection procedure. For each frequency to which at least one of the set of cells belongs, an offset value of frequency configured the network side will be used by the UE during the cell reselection procedure. However, when the UE in a RRC non-connected state reselects a cell where MRB configuration for multicast reception in RRC non-connected state is not provided, the UE will try to enter the RRC connected state to receive multicast. For example, when the UE in RRC_INACTIVE state reselects a cell where MRB configuration for multicast reception in RRC non-connected state is not provided, the UE will initialize a RRC connection resume procedure to enter the RRC connected state. In some other embodiments, if the UE cannot reselect a cell whose MRB configuration for multicast reception in RRC non-connected state is not provided for the UE, the UE may directly enter the RRC idle state.

Besides the methods, embodiments of the present application also propose an apparatus of supporting MBS.

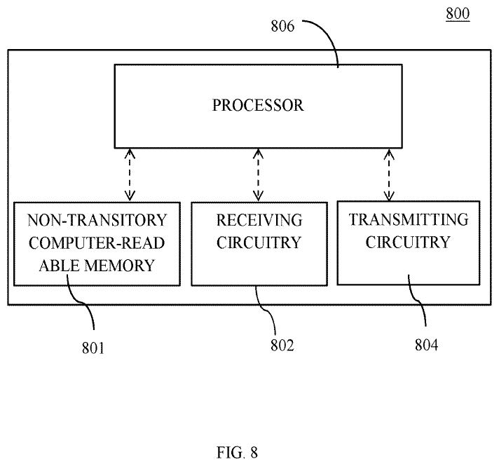

As shown in FIG. 8, the apparatus 800 may include at least one non-transitory computer-readable medium 801, at least one receiving circuitry 802, at least one transmitting circuitry 804, and at least one processor 806 coupled to the non-transitory computer-readable medium 801, the receiving circuitry 802 and the transmitting circuitry 804. The at least one processor 806 may be a CPU, a DSP, a microprocessor etc. The apparatus 800 may be a network apparatus or a UE configured to perform a method illustrated in the above or the like.

Although in this figure, elements such as the at least one processor 806, transmitting circuitry 804, and receiving circuitry 802 are described in the singular, the plural is contemplated unless a limitation to the singular is explicitly stated. In some embodiments of the present application, the receiving circuitry 802 and the transmitting circuitry 804 can be combined into a single device, such as a transceiver. In certain embodiments of the present application, the apparatus 800 may further include an input device, a memory, and/or other components.

In some embodiments of the present application, the non-transitory computer-readable medium 801 may have stored thereon computer-executable instructions to cause a processor to implement the method with respect to the network apparatus, e.g., a gNB as described above. For example, the computer-executable instructions, when executed, cause the processor 806 interacting with receiving circuitry 802 and transmitting circuitry 804, so as to perform the steps with respect to a network apparatus, e.g., a gNB as depicted above.

In some embodiments of the present application, the non-transitory computer-readable medium 801 may have stored thereon computer-executable instructions to cause a processor to implement the method with respect to the UE as described above. For example, the computer-executable instructions, when executed, cause the processor 806 interacting with receiving circuitry 802 and transmitting circuitry 804, so as to perform the steps with respect to a UE as illustrated above.

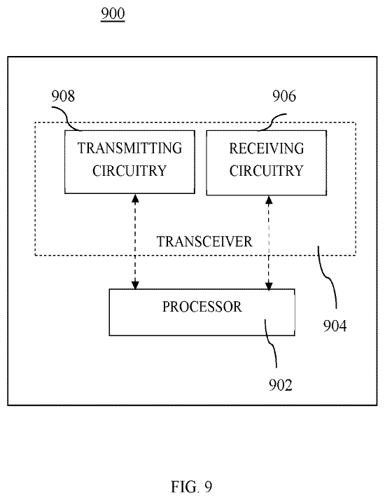

FIG. 9 is a block diagram of a wireless communication apparatus of supporting AI 900 according to some other embodiments of the present application.

Referring to FIG. 9, the apparatus 900, for example a gNB or a UE may include at least one processor 902 and at least one transceiver 904 coupled to the at least one processor 902. The transceiver 904 may include at least one separate receiving circuitry 906 and transmitting circuitry 908, or at least one integrated receiving circuitry 906 and transmitting circuitry 908. The at least one processor 902 may be a CPU, a DSP, a microprocessor etc.

According to some embodiments of the present application, when the apparatus 900 is a UE, the processor is configured to: receive at least one signaling indicating MRB configuration information for multicast reception in RRC non-connected state, wherein the at least one signaling is at least one of: a RRC dedicated signaling received in a RRC connected state or a RRC dedicated signaling received during a state transition from the RRC connected state to the RRC non-connected state; and in response to the UE transiting from the RRC connected state to the RRC non-connected state, receive multicast data of MRB in the RRC non-connected state based on the received MRB configuration information for multicast reception in RRC non-connected state.

According to some other embodiments of the present application, when the apparatus 900 is a UE, the processor may be configured to: receive an indication indicating that MRB configuration information for multicast reception is to be indicated only in RRC dedicated signaling, or only in MCCH, or in both of RRC dedicated signaling and MCCH; and receive the MRB configuration information for multicast reception based on the indication.

According to some other embodiments of the present application, when the apparatus 900 is a network apparatus, e.g., a gNB, the processor may be configured to: transmit at least one signaling indicating MRB configuration information for multicast reception in RRC non-connected state, wherein the at least one signaling is at least one of: a RRC dedicated signaling to be received by a UE in a RRC connected state or a RRC dedicated signaling to be received by the UE during a state transition from the RRC connected state to the RRC non-connected state; and transmit multicast data of MRB in the RRC non-connected state based on the MRB configuration information for multicast reception in RRC non-connected state.

According to some other embodiments of the present application, when the apparatus 900 is a network apparatus, e.g., a gNB, the processor may be configured to: transmit an indication indicating that MRB configuration information for multicast reception is to be indicated only in RRC dedicated signaling, or only in MCCH, or in both of RRC dedicated signaling and MCCH; and transmit the MRB configuration information for multicast reception based on the indication.

The method according to embodiments of the present application can also be implemented on a programmed processor. However, the controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device capable of implementing the flowcharts shown in the figures may be used to implement the processor functions of this application. For example, an embodiment of the present application provides an apparatus, including a processor and a memory. Computer programmable instructions for implementing a method are stored in the memory, and the processor is configured to perform the computer programmable instructions to implement the method. The method may be a method as stated above or other method according to an embodiment of the present application.

An alternative embodiment preferably implements the methods according to embodiments of the present application in a non-transitory, computer-readable storage medium storing computer programmable instructions. The instructions are preferably executed by computer-executable components preferably integrated with a network security system. The non-transitory, computer-readable storage medium may be stored on any suitable computer readable media such as RAMs, ROMs, flash memory, EEPROMs, optical storage devices (CD or DVD), hard drives, floppy drives, or any suitable device. The computer-executable component is preferably a processor but the instructions may alternatively or additionally be executed by any suitable dedicated hardware device. For example, an embodiment of the present application provides a non-transitory, computer-readable storage medium having computer programmable instructions stored therein. The computer programmable instructions are configured to implement a method as stated above or other method according to an embodiment of the present application.

In addition, in this disclosure, the terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The terms “having,” and the like, as used herein, are defined as “including.”

1. A user equipment (UE) for wireless communication, comprising:
at least one memory; and
at least one processor coupled with the at least one memory and configured to cause the UE to:
receive at least one signaling indicating multicast radio bearer (MRB) configuration information for multicast reception in radio resource control (RRC) non-connected state, wherein the at least one signaling is at least one of: a RRC dedicated signaling received in a RRC connected state or a RRC dedicated signaling received during a state transition from the RRC connected state to the RRC non-connected state; and
in response to the UE transiting from the RRC connected state to the RRC non-connected state, receive multicast data of MRB in the RRC non-connected state based on the received MRB configuration information for multicast reception in RRC non-connected state.

2. The UE of claim 1, wherein the MRB configuration information for multicast reception in RRC non-connected state is indicated by:
the RRC dedicated signaling received in the RRC connected state indicating the MRB configuration information of the UE for multicast reception; or
the RRC dedicated signaling received during the state transition, indicating multicast reception in the RRC non-connected state with continuing using the MRB configuration information of the UE for multicast reception.

3. The UE of claim 1, wherein the MRB configuration information for multicast reception in RRC non-connected state comprises a set of MRB configurations associated with a set of cells.

4. The UE of claim 3, wherein during the transition from the RRC connected state to the RRC non-connected state, the at least one processor is further configured to cause the UE to:
in response to determining that multicast reception is to be continued or multicast is to be received in the RRC non-connected state, select a cell which provides multicast service or prioritize selecting a cell that is provided an MRB configuration for multicast reception in the RRC non-connected state.

5. The UE of claim 1, wherein to receive the multicast in the RRC non-connected state comprises at least one of:
suspend or release a point to point (PTP) leg if any;
disable or suspend one or more dedicated MRB configurations for the RRC connected state;
continue to receive multicast of a point to multipoint (PTM) leg or receive multicast of a PTM leg of one or more corresponding MRBs in the RRC non-connected state;
suspend protocol data convergence protocol (PDCP) entities of all data radio bearers (DRBs) except corresponding MRBs;
perform partial media access control (MAC) reset; or
in response to determining that multicast is to be continued to be received or is to be received in the RRC non-connected state, select a cell which provides the multicast during the state transition.

6. The UE of claim 5, wherein to suspend the PDCP entities of all DRBs except corresponding MRBs comprises at least one of:
remaining a reordering timer in a case of the reordering timer running; or
continuing using an existing value of a state variable indicating a count value of a next PDCP service data unit (SDU) expected to be received and an existing value of a state variable indicating a count value of a first PDCP SDU being not delivered to upper layers but still waited for.

7. The UE of claim 1, wherein, the at least one processor is further configured to cause the UE to:
receive a timer for indicating valid time of the MRB configuration information for multicast reception in RRC non-connected state; and
enter the RRC connected state to update the MRB configuration information for multicast reception in RRC non-connected state in response to the timer expiring in the RRC non-connected state.

8. A user equipment (UE) for wireless communication, comprising:
at least one memory; and
at least one processor coupled with the at least one memory and configured to cause the UE to:
receive an indication indicating that multicast radio bearer (MRB) configuration information for multicast reception is to be indicated only in radio resource control (RRC) dedicated signaling, or only in multicast control channel (MCCH), or in both of RRC dedicated signaling and MCCH; and
receive the MRB configuration information for multicast reception based on the indication.

9. The UE of claim 8, wherein in a case that the indication indicates that the MRB configuration information for multicast reception is to be indicated only in MCCH, the at least one processor is further configured to cause the UE to:
receive the MRB configuration information for multicast reception in a MCCH, and the MRB configuration information for multicast reception is used for multicast reception in a RRC connected state and a RRC non-connected state.

10. The UE of claim 8, wherein in a case that the indication indicates that the MRB configuration information for multicast reception is to be indicated in both RRC dedicated signaling and MCCH, the at least one processor is further configured to cause the UE to:
receive the MRB configuration information for multicast reception in a RRC dedicated signaling in a RRC connected state and an MCCH,
wherein the MRB configuration information for multicast reception received in the RRC dedicated signaling is dedicated MRB configuration information for multicast reception in RRC connected state, and the MRB configuration information for multicast reception received in the MCCH is common MRB configuration information for multicast reception in RRC connected state and RRC non-connected state.

11. The UE of claim 10, wherein the at least one processor is further configured to cause the UE to:
receive multicast data of MRB in the RRC connected state by using the dedicated MRB configuration information for multicast reception in RRC connected state; and
receive the multicast data of MRB in the RRC non-connected state by using the dedicated MRB configuration information for multicast reception in RRC non-connected state.

12. The UE of claim 10, wherein in the RRC non-connected state, the at least one processor is further configured to cause the UE to:
monitor the MCCH and an MCCH update notification; and
suspend or release the dedicated MRB configuration information for multicast reception in RRC connected state.

13. The UE of claim 8, wherein in a case that the indication indicates that the MRB configuration information for multicast reception is to be indicated only in RRC dedicated signaling, the at least one processor is further configured to cause the UE to:
receive the MRB configuration information for multicast reception in a RRC dedicated signaling in a RRC connected state.

14. (canceled)

15. (canceled)

16. A processor for wireless communication, comprising:
at least one controller coupled with at least one memory and configured to cause the processor to:
receive at least one signaling indicating multicast radio bearer (MRB) configuration information for multicast reception in radio resource control (RRC) non-connected state, wherein the at least one signaling is at least one of: a RRC dedicated signaling received in a RRC connected state or a RRC dedicated signaling received during a state transition from the RRC connected state to the RRC non-connected state; and
in response to the processor transiting from the RRC connected state to the RRC non-connected state, receive multicast data of MRB in the RRC non-connected state based on the received MRB configuration information for multicast reception in RRC non-connected state.

17. The processor of claim 16, wherein the MRB configuration information for multicast reception in RRC non-connected state is indicated by:
the RRC dedicated signaling received in the RRC connected state indicating the MRB configuration information of the processor for multicast reception; or
the RRC dedicated signaling received during the state transition, indicating multicast reception in the RRC non-connected state with continuing using the MRB configuration information of the processor for multicast reception.

18. The processor of claim 16, wherein the MRB configuration information for multicast reception in RRC non-connected state comprises a set of MRB configurations associated with a set of cells.

19. The processor of claim 18, wherein during the transition from the RRC connected state to the RRC non-connected state, the at least one controller is configured to cause the processor to:
in response to determining that multicast reception is to be continued or multicast is to be received in the RRC non-connected state, select a cell which provides multicast service or prioritize selecting a cell that is provided an MRB configuration for multicast reception in the RRC non-connected state.

20. A processor for wireless communication, comprising:
at least one controller coupled with at least one memory and configured to cause the processor to:
receive an indication indicating that multicast radio bearer (MRB) configuration information for multicast reception is to be indicated only in radio resource control (RRC) dedicated signaling, or only in multicast control channel (MCCH), or in both of RRC dedicated signaling and MCCH; and
receive the MRB configuration information for multicast reception based on the indication.

21. The processor of claim 20, wherein in a case that the indication indicates that the MRB configuration information for multicast reception is to be indicated only in MCCH, the at least one controller is further configured to cause the processor to:
receive the MRB configuration information for multicast reception in a MCCH, and the MRB configuration information for multicast reception is used for multicast reception in a RRC connected state and a RRC non-connected state.

22. The processor of claim 20, wherein in a case that the indication indicates that the MRB configuration information for multicast reception is to be indicated in both RRC dedicated signaling and MCCH, the at least one controller is further configured to cause the processor to:
receive the MRB configuration information for multicast reception in a RRC dedicated signaling in a RRC connected state and an MCCH,
wherein the MRB configuration information for multicast reception received in the RRC dedicated signaling is dedicated MRB configuration information for multicast reception in RRC connected state, and the MRB configuration information for multicast reception received in the MCCH is common MRB configuration information for multicast reception in RRC connected state and RRC non-connected state.
